(19) United States
(12) Patent Application Publication
(10) Pub. No.: US 2023/0271818 A1
(43) Pub. Date: Aug. 31, 2023

(54) HANDLING MACHINE HAVING AN ARM AND CORRESPONDING ALERT METHOD

(71) Applicant: MANITOU BF, ANCENIS (FR)

(72) Inventor: Julien LE DU, ANCENIS (FR)

(21) Appl. No.: 18/005,454

(22) PCT Filed: Jul. 23, 2021
(86) PCT No.: PCT/FR2021/051384

§ 371 Date: Jan. 13, 2023

(30) Foreign Application Priority Data
Jul. 23, 2020 (FR) 2007777

(51) Int. Cl. B66F 17/00; B66F 9/065; B66F 9/075

(52) U.S. Cl. CPC B66F 17/003; B66F 9/0655; B66F 9/0755

(57) ABSTRACT

The invention relates to a rolling handling machine (1) having an arm. The machine comprises an alert system comprising a memory in which are stored a plurality of alert rules for triggering at least one action from among transmitting data relating to the determined values of said parameters to a remote server (31); and emitting a visual, and/or sound, and/or vibration signal to alert the machine's driver. The triggering of an action occurs according to the speed of movement of the machine and the angular position of the arm. The invention also relates to an alert method and to a corresponding program product.

### FIELD OF THE INVENTION

The invention relates to the field of wheeled handling machines having a handling arm.

Such a machine can in particular be produced in the form of a truck with a telescopic arm, a power shovel, a bucket loading machine or the like.

### PRIOR ART

Users of wheeled handling machines sometimes exhibit risky behavior. In particular, some users may have a tendency to drive at an excessive speed with the handling arm in the raised position, and this generates a risk of the machine tipping over, which the user may not be aware of or may underestimate.

The document EP1593642 describes a handling machine in which a plurality of operating parameters are determined so as to control the setting of the steering of the machine.

The document EP3666720 A1 describes a handling machine with a safety system that includes a plurality of load diagrams, and a limitation module configured to limit the possibility of operation of actuators of the machine as a function of a load diagram.

The aim of the present invention is to propose a novel machine and a novel method for mitigating all or some of the problems set out above.

### SUMMARY OF THE INVENTION

To this end, one subject of the invention is a handling machine comprising:
a wheeled chassis;
a lifting arm articulated to the wheeled chassis so as to be able to be pivoted between a lowered position and a raised position,
   characterized in that the machine also comprises a system for determining values of parameters of the machine, configured to determine values of a group of parameters comprising:
a parameter relating to the speed of movement of the machine; and
a parameter relating to the angular position of the arm;
   said machine being configured to make it possible to trigger at least one warning action from the following group of actions:
transmission to a remote server of data relating to the determined values of said parameters; and
emission of a visual, and/or audible, and/or vibratory signal to warn the driver of the machine;
   the machine also comprising a warning system having a memory in which a plurality of warning rules are stored,
   the plurality of warning rules comprising:
a first rule according to which a first action of said group of actions or a first set of actions of said group of actions is triggered when the values of said parameters exceed a first set of threshold values;
a second rule according to which a second action of said group of actions, distinct from the first action, or a second set of actions of said group of actions, comprising at least one action distinct from said first action or distinct from an action of said first set of actions, is triggered when the values of said parameters exceed a second set of threshold values.

Another subject of the invention is a handling machine comprising:
a wheeled chassis;
a lifting arm articulated to the wheeled chassis so as to be able to be pivoted between a lowered position and a raised position,
   characterized in that the machine also comprises a system for determining values of parameters of the machine, configured to determine values of a group of parameters comprising:
a parameter relating to the speed of movement of the machine; and
a parameter relating to the angular position of the arm;
   said machine being configured to make it possible to trigger at least one warning action from the following group of actions:
transmission to a remote server of data relating to the determined values of said parameters; and
emission of a visual, and/or audible, and/or vibratory signal to warn the driver of the machine;
   the machine also comprising a warning system having a memory in which a plurality of warning rules are stored, each warning rule having:
a threshold value for each of said parameters; and
at least one action to be triggered from said group of actions,
   the machine being configured to trigger said at least one warning action as a function of the result of the comparison of the determined values of the parameters with the corresponding threshold values defined in said warning rule.

An idea underlying this invention is to provide a handling machine with an arm, in which a plurality of warning rules are established as a function of various driving (operating) conditions of the machine, with various associated warning actions that are adapted to the determined driving conditions, in order to be able to warn the driver and/or a remote operator, such as the renter of the machine, and possibly a person present in the external environment close to the machine, such as a person on a building site, of potentially dangerous driving.

Such a solution makes it possible to improve the driving (or operating) safety of handling machines, by allowing the driver to be warned in real time so as to be able to correct the way in which they drive the machine, and also allowing a remote operator to be warned, by virtue of the communication of the machine with the remote server, of inappropriate driving, and this allows the remote operator, such as a manager of a machine rental site, to have reliable information on the way in which the machine is driven by the driver, in particular so as to remind the driver of good driving practice, and/or to anticipate the risk of an accident, in particular by the handling machine tipping over.

Such a design of the handling machine using a plurality of warning rules preferably with various associated warning actions to be triggered, depending on the driving conditions of the vehicle, makes it possible to trigger one or more warning actions in a coherent manner with respect to the driving conditions and therefore the associated danger.

According to one embodiment, when the machine is moving but under conditions corresponding to a low or zero risk of tipping over, provision can be made for the machine to simply transmit to the remote server data corresponding to these conditions of movement, to allow monitoring or subsequent analysis of the driving of the machine, but without a warning action for the driver so as not to disturb them. When the driving conditions change, increasing the risk of tipping over, the machine can not only transmit the corresponding data to the remote server, but also warn the driver so that they become aware of the risk and correct their driving, and possibly trigger a warning action intended for the external environment close to the machine, for example by switching on a rotating beacon of the machine.

The machine may have one or more of the following features in any technically admissible combination.

According to one embodiment, said group of parameters also comprises at least one of said following parameters:
the steering angle of the front and/or rear wheels of the machine;
the inclination of the machine with respect to the vertical.

According to one embodiment, the group of parameters also comprises the open or closed state of the door of the cab.

According to one embodiment, the group of parameters also comprises the fastened or unfastened state of the seatbelt when the driver is seated in the cab.

According to one embodiment, the group of parameters also comprises the mode of steering the wheels, which defines whether the front and/or rear wheels are steered, and/or whether the front and rear wheels are turned in the same direction or in opposite directions.

According to one embodiment, said arm being a telescopic arm, the group of parameters also comprises the extension length of the arm.

According to one embodiment, the group of actions further comprises the action of triggering the emission of a visual and/or audible signal outside the machine, for example using a rotating beacon, to warn a person in the external environment of the machine.

According to one embodiment, the warning system of the machine is configured to:
when the determined values of the pair of parameters formed by the speed of movement and the arm angle exceed a first pair of associated threshold values, trigger transmission to a remote server of data relating to the determined values of said parameters; and
when the determined values of the pair of parameters corresponding to the speed of movement and to the arm angle exceed a second pair of associated threshold values, of which at least one of said threshold values is greater than the corresponding threshold value of the first pair of threshold values, trigger transmission to the remote server of data relating to the determined values of the parameters, and also the emission of a visual, and/or audible, and/or vibratory signal to warn the driver of the machine.

In other words, the second pair of threshold values is greater than the first pair of threshold values.

According to one embodiment, said transmission to a remote server of data relating to the determined values of said parameters, triggered following the exceeding of the first pair of threshold values, is carried out without warning the driver in order not to disturb them.

According to one embodiment, the machine is configured to, when the determined values of the pair of parameters corresponding to the speed of movement and to the arm angle exceed a third pair of associated threshold values, of which at least one of said threshold values is greater than the corresponding threshold value of the second pair, trigger transmission to the remote server of data relating to the determined values of said parameters, and also the emission of a visual and/or audible signal using a device of the machine, present outside the cab of the machine, to warn the external environment of the machine.

In other words, the third pair of threshold values is greater than the second pair of threshold values.

The invention also relates to an assembly comprising a machine as proposed above and said remote server.

The invention also relates to a method for warning of driving risk, in particular of risk of tipping over, for a handling machine, for example as proposed above, comprising a wheeled chassis and a lifting arm articulated to the wheeled chassis so as to be able to be pivoted between a lowered position and a raised position, characterized in that the method comprises the following steps:
determination of first values of the parameters of speed of movement and of arm angle of the machine;
comparison of the first determined values of said parameters with first threshold values,
as a function of the result of the comparison, triggering at least one first warning action from the following group of actions:
transmission to a remote server of data relating to the determined values of said parameters; and
   the method also comprising the steps of:
emission of a visual, and/or audible, and/or vibratory signal to warn the driver of the machine;
determination of second values of said parameters of the machine;
comparison of the second determined values of said parameters with second threshold values;
as a function of the result of the comparison, triggering at least one second action, different from said at least one first action, from said group of actions.

The invention also relates to a non-transient computer program product comprising program code instructions for executing the steps of a method as proposed above when said program is executed by a processor of a handling machine.

According to various embodiments, there is also proposed a method for warning of driving risk, in particular of risk of tipping over, for a handling machine, such as that proposed above, characterized in that the method comprises the following steps:
determination of first values of parameters of the machine;
comparison of the first determined values of said parameters with first threshold or state values,
as a function of the result of the comparison, triggering at least one first warning action from the following group of actions:
transmission to a remote server of data relating to the determined values of said parameters; and
emission of a visual, and/or audible, and/or vibratory signal to warn the driver of the machine;
   the method also comprising the steps of:
determination of second values of parameters of the machine;
comparison of the second determined values of said parameters with second threshold or state values;
as a function of the result of the comparison, triggering at least one second action, different from the first action, from said group of actions.

According to various embodiments, there is also proposed a handling machine comprising a wheeled chassis and a system for determining values of parameters of the machine, configured to determine values of a group of parameters of the machine, said machine being configured to make it possible to trigger at least one warning action from the following group of actions comprising transmission to a remote server of data relating to the determined values of said parameters; and emission of a visual, and/or audible, and/or vibratory signal to warn the driver of the machine;

the machine also comprising a warning system having a memory in which a plurality of warning rules are stored, each warning rule having a threshold or state value for each of said parameters; and at least one action to be triggered from said group of actions,
the machine being configured to trigger said at least one warning action as a function of the result of the comparison of the determined values of the parameters with the corresponding threshold or state values defined in said warning rule.

### BRIEF DESCRIPTION OF THE DRAWINGS

Other features and advantages of the invention will become more apparent from the following description, which is purely illustrative and non-limiting and should be read in conjunction with the appended drawings, in which:

FIG. 1 is a schematic view of a handling machine according to one embodiment of the invention;

FIG. 2 is a schematic view of a warning system of a handling machine according to one embodiment of the invention;

FIG. 3 is a view of a matrix giving levels of actions to be triggered, which levels are associated with various pairs of threshold values defined for parameters of speed of movement and of arm angle for a handling machine according to one embodiment of the invention;

FIG. 4 is a diagram that illustrates, in the form of a table, the one or more actions triggered as a function of exemplary values of the parameters of speed of movement and of arm angle for a handling machine according to one embodiment of the invention;

FIG. 5 is a diagram that illustrates, in the form of a table, the one or more actions triggered as a function of exemplary values of the parameters of the door and of speed of movement of the machine for a handling machine according to one embodiment of the invention;

FIG. 6 is a diagram that illustrates, in the form of a table, the one or more actions triggered as a function of exemplary values of the parameters of the seatbelt and of speed of movement for a handling machine according to one embodiment of the invention;

FIG. 7 is a diagram illustrating a handling machine communicating with a remote server, according to one embodiment of the invention.

FIG. 8 is a diagram illustrating steps of a warning method according to one embodiment of the invention.

### DETAILED DESCRIPTION

The concept of the invention is described more fully below with reference to the appended drawings, which show embodiments of the concept of the invention. In the drawings, the size and the relative sizes of the elements may be exaggerated for the sake of clarity. Similar numbers refer to similar elements throughout the drawings. However, this concept of the invention may be implemented in many different forms and should not be interpreted as being limited to the embodiments set out here. Instead, these embodiments are provided such that this description is complete, and communicate the scope of the concept of the invention to those skilled in the art.

Reference throughout the specification to “an/one embodiment” means that a particular functionality, structure or feature described in relation to one embodiment is included in at least one embodiment of the present invention. Thus, the occurrence of the expression “in one embodiment” in various places throughout the specification does not necessarily refer to the same embodiment. Furthermore, the particular functionalities, structures or features may be combined in any suitable manner in one or more embodiments.

A handling machine is thus proposed that makes it possible to alert or warn the driver and/or a third party in the event of risky driving (or operation) in order to enable the driver to become aware of the associated risk and to correct the driving of the machine.

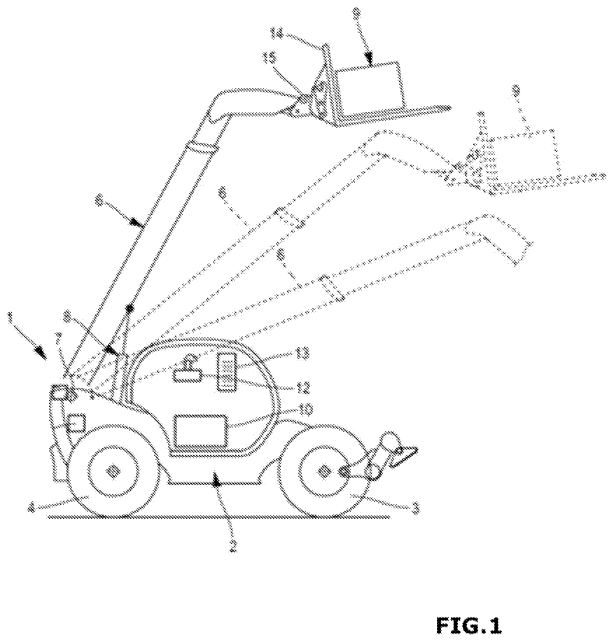

In FIG. 1, a handling machine 1 with a handling arm has been shown. The handling machine 1 can also be called a handling truck.

The handling machine 1 comprises a wheeled chassis 2 supported on the ground via a front axle 3 and a rear axle 4.

The handling machine 1 comprises a motorized system for moving the machine. The motorized system for moving the machine comprises, for example, an electric motor and/or an internal combustion engine, and a system for transmission to the wheels and steering control making it possible to move the machine.

The wheeled chassis 2 bears a handling device and an actuation system that makes it possible to move said handling device with respect to the chassis 2.

In the example of FIG. 1, the handling device comprises an arm 6, usually called a lifting arm, articulated to the wheeled chassis 2 so as to be able to be moved between what is known as a lowered position and a raised position.

The handling machine includes a control system, comprising for example a computer, which allows the operator, via a human-machine interface (which can comprise a driving member, such as a joystick) to operate the handling machine, and in particular to bring about the movement of the machine and/or the position of the arm 6.

### Wheeled Chassis

The wheeled chassis 2 comprises a cab 20 having a door allowing an operator to sit in the cab 20 to operate the machine.

The cab 2 is equipped with a seatbelt for the operator and a corresponding system for fastening and unfastening the seatbelt.

### Lifting Arm

The lifting arm 6 (or handling arm) is mounted on the frame 2 and can be oriented about an axis of rotation 7. In particular, said axis of rotation 7 is horizontal when the wheeled chassis 2 is resting on horizontal ground. The arm 6 projects toward the front of the machine. According to one embodiment, the axis 7 is closer to the rear axle than to the front axle of the machine.

The arm 6 is equipped with a load carrier 14, such as a fork or bucket system, articulated to the arm 6 by a link 15 and configured to carry a payload 9.

In the example illustrated in FIG. 1, the arm 6 is of the telescopic type. The arm 6 thus comprises at least two segments that can be deployed using a deployment ram, not shown, arranged between the at least two segments. Alternatively, the arm may be a non-telescopic arm.

In the example of FIG. 1, the actuating device of the arm includes in particular a lifting actuator, for example a hydraulic ram 8, which makes it possible to move the arm 6 up and down about the horizontal axis 7, under the control of the control system. Alternatively, the lifting actuator can be an electric ram.

The control system can comprise a computer 10 that makes it possible to control the lifting actuator, for example by means of a hydraulic circuit (not shown), as a function of the action of the operator upon a control member 12, such as a joystick.

The hydraulic circuit may comprise a source of hydraulic pressure and a hydraulic distributor interposed between the source of hydraulic pressure and a solenoid valve for controlling the hydraulic ram 8. The solenoid valve for controlling the hydraulic ram 8 can be controlled by the control system.

### Sensors

The machine comprises sensors that make it possible, for example by being connected to a computer, such as the computer 10, to determine values of various parameters of the handling machine.

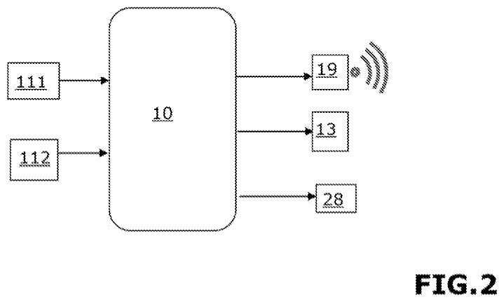

As shown schematically in FIG. 2, the machine thus includes an electronic and computer system that comprises a processing unit, such as the computer 10, to which there can be connected one or more sensors 111, 112, and also electrical or electronic equipment 19, 13, 28, which can be controlled by the processing unit. As explained below, the electrical or electronic equipment to be controlled may comprise, for example, a display screen, one or more indicator lights, a rotating beacon, and/or a wireless communication module.

According to a particular aspect, the electronic and computer system of the machine comprises, for example in the computer, a processor that makes it possible to execute instructions of a computer program, such as a warning program presented below, and a memory in which said warning program can be stored.

The warning program uses as input parameters the determined values of the parameters to be monitored so as to compare them with threshold or state values, and then trigger one or more actions for controlling electrical or electronic equipment of the machine, as a function of the result of the comparison.

According to one embodiment, provision may be made for the threshold or state values, which are associated with parameters to be monitored, to be recorded in a memory, which may be separate or entirely or partially common with the memory for storing the program.

### Exemplary Sensors

In the embodiment illustrated in FIG. 2, the handling machine comprises a sensor 111 for the speed of movement of the machine and a sensor 112 for the angle of the arm. The sensor for the speed of movement of the machine can be produced in different ways, for example with a frequency sensor on the output shaft of the gearbox of the machine. The sensor for the arm angle can be produced in a different way, for example by instrumentation of the axis of pivoting of the arm with respect to the frame or an analog angle sensor, for example with redundant signals with crossed tracks. The angle of the arm is determined with respect to a reference position, preferably with respect to the horizontal when the wheeled chassis is resting on a horizontal plane.

The machine can comprise other sensors of which the values of the corresponding parameters can be taken into account so as to trigger one or more warning actions.

Provision may thus be made for other sensors to make it possible to determine:
the steering angle of the (front and/or rear) wheels of the machine; and/or
the extension length of the arm when said arm is a telescopic arm; and/or
the inclination of the machine with respect to the vertical; and/or
the open or closed state of the door of the cab; and/or
the fastened or unfastened state of the seatbelt of the driver; and/or
a parameter representative of the loading of the rear axle of the machine.

Preferentially, the handling machine is configured to allow the operator to define, preferably via a human-machine interface, such as a button, a loading mode, so as to select a “fork” mode, corresponding to a load carried on the handling tool (forks, bucket, etc.) at the end of the arm, or a “suspended load” mode corresponding to a load that hangs below said tool.

Preferentially and similarly, the handling machine is configured to make it possible to define the mode of steering the wheels in order to define whether the front and/or rear wheels are steered, and/or whether the front wheels and the rear wheels are turned in the same direction (for crab-type transverse movement) or in opposite directions (to benefit from significant steering).

The selection of the loading mode and/or of the steering mode is stored in the processing unit.

Provision may thus be made for the threshold values associated with one or more parameters other than the steering mode to be functions of the selected steering mode. Likewise, provision may be made for the threshold values associated with one or more parameters other than the loading mode to be functions of the selected loading mode.

### Radio Communication Module

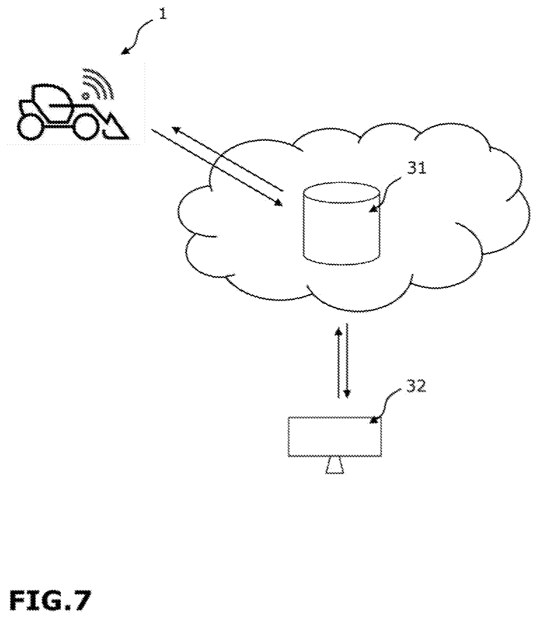

The handling machine comprises a radio communication module 19 configured to communicate with a wireless communication network so as to transmit to a remote server 31 data relating to the monitored parameters (FIG. 7). This data may comprise the values of the monitored parameters (processed or not) and/or corresponding alert or warning messages. The data transmitted by the radio communication module 19 may further comprise an identifier of the handling machine and possibly an identifier of the driver. It is understood that the remote server can be formed by one or more servers.

The remote server 31 is a server on which a computer application is installed to allow a remote user to access, via a terminal 32, such as a smartphone or a computer, the data transmitted by the radio communication module of the handling machine. Provision can be made for this data to be processed, for example in the server, or for this data to be raw data, for example so that the remote user can apply a particular processing program to this data.

The wireless communication network preferably comprises a cellular-type wireless network such as a mobile telephony network (GSM, GPRS, 3G, 4G, 5G, etc.) and/or an Internet of Things network (LORA, SIGFOX, etc.).

The components of the electronic and computer system that are used for monitoring the parameters of the machine and the emission of data and/or warning messages may be entirely or partially common with the components of the electronic and computer system used for operating the machine.

### Display Device

Advantageously, the handling machine comprises a display screen present inside the cab that makes it possible to display warning messages, for example in the form of pop-up windows.

These pop-up windows can appear in a fixed manner as long as a condition for closing said window is not fulfilled, or disappear automatically after a given duration.

According to a particular embodiment, the handling machine comprises, alternatively or in combination with the display screen, one or more indicator lights, which can be switched off or on depending on the information to be transmitted to the driver.

The machine may comprise, alternatively or combined with the display screen or the indicator lights, audible and/or vibratory emission devices for warning the driver.

### Parameters of the Machine to be Monitored

The handling machine thus makes it possible to monitor various driving (or operating) parameters of the machine.

These parameters to be monitored can be driving or operating parameters of the machine, and in particular the speed of forward movement of the machine and the angle of the lifting arm. Additional parameters can be taken into account such as the steering angle of the wheels, and/or the inclination of the machine, and/or the extension length of the arm when the latter is telescopic.

The parameters to be monitored can also comprise parameters of operating mode of the machine, for example the activated or non-activated state of the “fork” mode or of the “suspended load” mode, or else a mode of steering the wheels of the machine.

### Threshold or State Values

As recalled above, the warning program uses, for each parameter to be monitored, one or more threshold values, or one or more predefined state values, which make it possible to define rules for triggering one or more actions as a function of the comparison of the determined values of the parameters of the machine with these threshold or state values.

Thus, each rule defines, for a set of parameters of the machine, the conditions under which the values of these parameters trigger the one or more actions associated with said rule.

### Rules

A rule comprises the conditions for triggering one or more actions and the one or more associated triggered actions.

In the examples illustrated in the figures, the warning program comprises at least a first rule associated with given parameters of the machine making it possible to trigger a first level of action comprising one or more actions and a second rule that, associated with these parameters of the machine, makes it possible to trigger a second level of action comprising one or more actions of which at least one action is different from the one or more actions of the first level of action.

Of course, provision can be made for rules to present actions to be triggered, which are entirely distinct from one another.

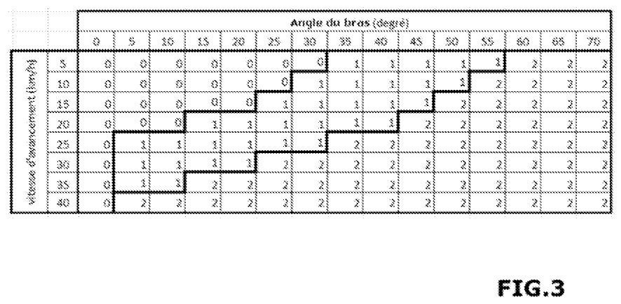

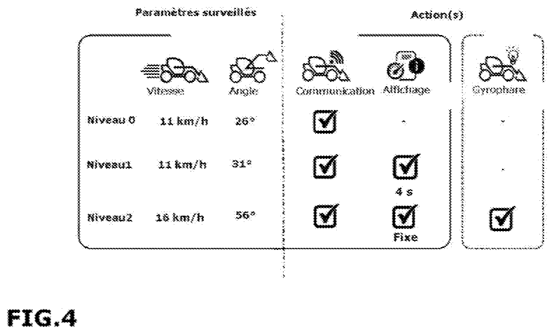

An exemplary set of rules is illustrated using a matrix in FIG. 3 for the parameters of speed of movement of the machine and of angle of the arm. Each pair of threshold values (threshold speed, threshold angle) is associated with a level of action to be triggered when the values of the monitored parameters exceed these threshold values. As explained below in connection with FIG. 4, an action level “0” is thus defined for which only communication of data to a remote server is carried out (the machine does not send a signal to the driver so as not to not disturb them). This level is associated with pairs of threshold values corresponding to a low level of risk of tipping over. For a higher level of risk of tipping over, an action level “1” is defined for which not only is communication of data to a remote server carried out, but the machine also controls the display, for a given duration, of a message on a screen visible to the driver (or the emission of a visual or audible or vibratory signal in the cab). For a more significant level of risk of tipping over, an action level “2” is defined for which communication of data to a remote server is carried out, and the machine controls the display of a message on a screen visible to the driver (or the emission of a visual or audible or vibratory signal in the cab) without a time limit, and the machine possibly controls the activation of a rotating beacon of the machine. It is thus possible to provide a response that is graded as a function of the change in the determined driving conditions.

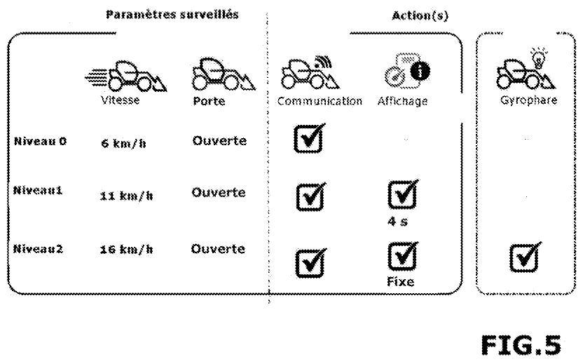

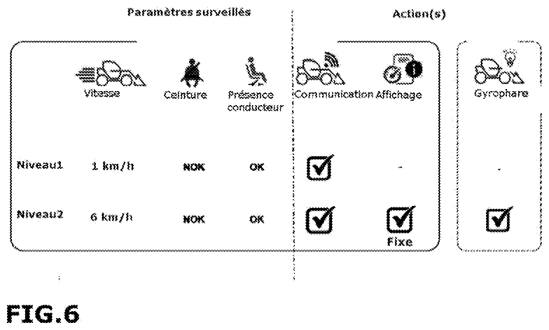

Other rules using other parameters can also be implemented in the machine, for example in the form of a matrix of the type of that of FIG. 2, with other parameters in addition or alternatively, it being possible for the matrix to have a dimension greater than two. This matrix (not represented for the examples of FIGS. 5 and 6) can thus comprise other parameters such as the parameters of speed and of the door used in the example of FIG. 5, or the parameters of speed and of the seatbelt used in the example of FIG. 6.

The rules can also be defined in the form of a mathematical law or function.

### EXAMPLES OF FIGS. 4 TO 6

Thus, in the example illustrated in FIG. 4, which takes into account the parameters of speed of movement of the machine and of arm angle of the machine, when the determined speed of the machine (here 11 km/h) is greater than or equal to a first threshold value, here 10 km/h, and the determined angle of the arm of the machine (here 26°) is greater than or equal to a second threshold value, here 25°, then the machine transmits, via the radio communication module 19, data relating to said speed of the machine and to the arm angle thus monitored to the remote server 31.

When the determined speed of the machine (here again 11 km/h) is greater than or equal to a third threshold value, here again 10 km/h, and the determined angle (here 31°) of the arm of the machine is greater than or equal to a fourth threshold value, here 30°, then the machine transmits to the remote server 31, via the radio communication module 19, data relating to said speed of the machine and to the arm angle thus monitored, and displays on a screen present in the cab of the machine a warning message and/or switches on one or more indicator lights visible to the driver to warn them of risky driving. Since the risk, in particular of tipping over, is considered to be moderately high, provision can be made for the visual message to disappear after a given time, for example 4s.

When the determined values (here {16 km/h; 56°}) of the pair corresponding to the speed of the machine and to the arm angle are greater than or equal to another pair of corresponding threshold values, for example the pair of threshold values {16 km/h; 55°}, then the machine transmits to the remote server 31, via the radio communication module 19, data relating to said speed of the machine and to the arm angle thus monitored, displays on a screen a warning message and/or switches on one or more indicator lights visible to the driver to warn them of risky driving. Since the risk, in particular of tipping over, is considered to be significant, provision may be made for the message to be maintained, at least as long as the values of the speed of the machine and of the arm angle remain greater than or equal to said corresponding pair of threshold values. Provision can also be made for an additional action to be triggered, such as the switching on of a rotating beacon of the machine.

As visible in the example of FIG. 4, for two distinct rules, provision can be made for some of the actions triggered, such as the transmission of data to the remote server 31, to be common to these two rules.

Similarly, in the example of FIG. 5, which takes into account the parameters of speed of movement of the machine and of position of the door of the cabin, an action of transmitting data to the remote server 31 is carried out when the machine is traveling at a speed (here 6 km/h) greater than or equal to a given speed, for example 5 km/h, and the door is in the open position. When the speed of movement increases, for example for a speed greater than or equal to 10 km/h, the machine is configured not only to transmit corresponding data to the remote server, but also to display an alert message that may be temporary (level 1), for example between 10 and 15 km/h, or fixed (level 2), for example above 15 km/h, depending on the speed of movement. As before, an action of switching on a rotating beacon can also be triggered.

In addition, in the example of FIG. 6, which takes into account the parameters of speed of movement of the machine and of fastening of the seatbelt (“NOK” state when the belt is unfastened) when the driver is present (“OK” state relating to the presence of the driver, detected for example using a weight sensor), an action of transmitting data to the remote server 31 is carried out when the machine is traveling at a non-zero speed and the driver has not fastened their seatbelt. When the speed of movement increases (here to 6 km/h) and exceeds a given threshold value, for example a threshold value of 5 km/h, and the belt remains unfastened, the machine is configured not only to transmit corresponding data to the remote server, but also to display an alert message that is preferably fixed. As before, an action of switching on a rotating beacon can also be triggered.

Provision can be made for an operator, such as the renter, to be able to deactivate the message display for a given level of action, such as level 1, but for the message display to remain active for another level such as level 2.

The operating unit of the handling machine can be configured to execute all or some of the warning rules with the corresponding parameters presented in the examples above. In other words, the machine can be configured to be able to execute one or more of the above examples.

### Set of Machines

Provision can be made, for a set of a plurality of machines, for the rules implemented in each machine to be functions of the machine and possibly of the drivers of these machines. The rules can thus be different from one machine to another or else from one driver to another, for example by defining corresponding machine profiles and/or user profiles.

The remote server can thus receive data originating from different handling machines.

Provision can be made for at least some of the rules, possibly each rule, to lead to no direct action (i.e. no automatic action that would be triggered without driver intervention) on the control of one or more operating members of the machine, in particular no automatic action of braking and/or lowering of the arm, so as not to risk surprising the driver of the machine, the warning messages being provided to warn the operator so that they correct their way of operating (driving) the machine themselves.

### Warning Method

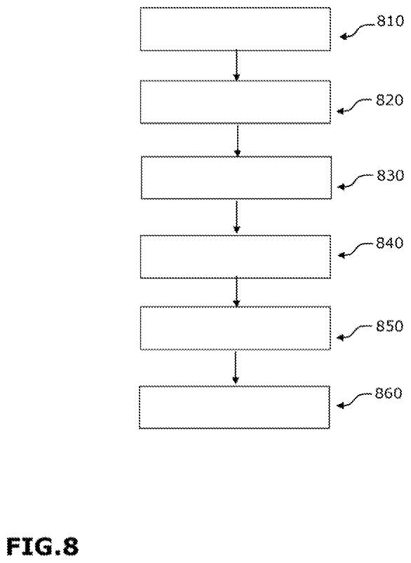

The handling machine presented above makes it possible to implement a warning method described below in connection with FIG. 8. In step 810, the handling machine 1 determines (by measurement and/or calculation) first values of the parameters of speed of movement and of arm angle of the machine using corresponding sensors with which the machine is equipped. Using a processing unit of the machine, the first determined values of said parameters are compared with first threshold values or state values (step 820). When said first determined values are greater than or equal to the first threshold values (while remaining lower than second threshold values used to trigger one or more other actions), the processing unit triggers, in step 830, the transmission to the remote server 31 of data relating to the first determined values of said parameters.

Then, when the handling machine 1 determines (by measurement and/or calculation) second values of said parameters of speed of movement and of arm angle of the machine (step 840), of which at least one of said second values is greater than the first determined value of the corresponding parameter (the second determined value of the other parameter being able to be equal to or greater than the first determined value of said other parameter), the processing unit of the machine compares, in step 850, the second determined values of said parameters with the second threshold values (of which at least one of said second threshold values is greater than the first threshold value of the corresponding parameter). When said second determined values are greater than or equal to the second threshold values, the processing unit triggers, in step 860, not only the transmission to the remote server 31 of data relating to the second determined values of said parameters, but also the emission of a visual, and/or audible, and/or vibratory signal to warn the driver of the machine.

The Plurality of Warning Rules Comprises:
a first rule according to which a first action of said group of actions or a first set of actions of said group of actions is triggered when the values of said parameters exceed a first set of threshold values (while remaining below a second set of threshold values);
a second rule according to which a second action of said group of actions, distinct from the first action, or a second set of actions of said group of actions, comprising at least one action distinct from said first action or distinct from an action of said first set of actions, is triggered when the values of said parameters exceed the second set of threshold values.

The first rule thus makes it possible to trigger the transmission to a remote server of data linked to the values of speed of movement of the machine and of the arm angle when these values exceed a first level of threshold values. And the second rule also makes it possible to trigger the display, intended for the driver, of data linked to the values of speed of movement of the machine and of the arm angle when these values exceed a second level of threshold values higher than the first level of threshold values.

The second pair (or set) of threshold values of the parameters is greater than the first pair (or set) of threshold values because at least one of the second threshold values is greater than the first threshold value of the corresponding parameter. The second threshold value of the other parameter may be greater than or equal to the first threshold value of said other parameter. A third pair (or set) of threshold values of the parameters (greater than the second pair of threshold values), making it possible to trigger one or more other actions according to a third rule, can also be used by the warning system of the machine.

As explained above, the method can also provide for the triggering of a device outside the cabin, such as a rotating beacon.

Electronic and/or Computer System

As recalled above, the warning system described above that makes it possible to monitor certain parameters of the machine and to warn the driver and/or a nearby or remote third party using a server, can be produced entirely or partially in common with the electronic and computer system and in particular the processing unit with which the machine is equipped to allow the operation of said machine, or be separate.

The functions and steps described above, in particular relating to the warning method and system, may be implemented in the form of a computer program or via hardware components (for example programmable gate arrays). In particular, the functions and steps carried out by the processing unit and/or the warning system may be performed by sets of instructions or computer modules implemented in a processor or controller or be performed by dedicated electronic components or FPGA or ASIC components. It is also possible to combine computer parts and electronic parts.

When it is stated that a processing unit, or a computer, or the warning system is configured to perform a given operation, this means that this unit, computer or warning system comprises computer instructions and the corresponding execution means that make it possible to perform said operation and/or that this unit, computer or warning system comprises corresponding electronic components.

The invention is not limited to the embodiments illustrated in the drawings.

In addition, the term “comprising” does not rule out other elements or steps. In addition, features or steps that have been described with reference to one of the embodiments set out above may also be used in combination with other features or steps of other embodiments set out above.

1. A handling machine (1) comprising:
a wheeled chassis (2);
a lifting arm (6) articulated to the wheeled chassis (2) so as to be able to be pivoted between a lowered position and a raised position,
characterized in that the machine (1) also comprises a system (10, 111, 112) for determining values of parameters of the machine, configured to determine values of a group of parameters comprising:
a parameter relating to the speed of movement of the machine; and
a parameter relating to the angular position of the arm (6);
said machine being configured to make it possible to trigger at least one warning action from the following group of actions:
transmission to a remote server (31) of data relating to the determined values of said parameters; and
emission of a visual, and/or audible, and/or vibratory signal to warn the driver of the machine;
the machine (1) also comprising a warning system having a memory in which a plurality of warning rules are stored,
the plurality of warning rules comprising:
a first rule according to which a first action of said group of actions or a first set of actions of said group of actions is triggered when the values of said parameters exceed a first set of threshold values;
a second rule according to which a second action of said group of actions, distinct from the first action, or a second set of actions of said group of actions, comprising at least one action distinct from said first action or distinct from an action of said first set of actions, is triggered when the values of said parameters exceed a second set of threshold values.

2. The machine as claimed in claim 1, wherein said group of parameters also comprises at least one of said following parameters:
the steering angle of the front and/or rear wheels of the machine;
the inclination of the machine with respect to the vertical.

3. The machine as claimed in either one of claims 1 and 2, wherein the group of parameters also comprises the open or closed state of the door of the cab.

4. The machine as claimed in any one of claims 1 to 3, wherein the group of parameters also comprises the fastened or unfastened state of the seatbelt when the driver is seated in the cab.

5. The machine as claimed in any one of claims 1 to 4, wherein the group of parameters also comprises the mode of steering the wheels, which defines whether the front and/or rear wheels are steered, and/or whether the front and rear wheels are turned in the same direction or in opposite directions.

6. The machine as claimed in any one of claims 1 to 5, wherein, said arm being a telescopic arm, the group of parameters also comprises the extension length of the arm.

7. The machine as claimed in any one of claims 1 to 6, wherein the group of actions further comprises the action of triggering the emission of a visual and/or audible signal outside the machine, for example using a rotating beacon, to warn a person in the external environment of the machine.

8. The machine as claimed in any of claims 1 to 7, wherein the warning system of the machine is configured to:
when the determined values of the pair of parameters formed by the speed of movement and the arm angle exceed a first pair of associated threshold values, trigger transmission to a remote server (31) of data relating to the determined values of said parameters; and
when the determined values of the pair of parameters corresponding to the speed of movement and to the arm angle exceed a second pair of associated threshold values, of which at least one of said threshold values is greater than the corresponding threshold value of the first pair of threshold values, trigger transmission to the remote server (31) of data relating to the determined values of the parameters, and also the emission of a visual, and/or audible, and/or vibratory signal to warn the driver of the machine.

9. The machine as claimed in any one of claims 1 to 8, wherein said transmission to a remote server (31) of data relating to the determined values of said parameters, triggered following the exceeding of the first pair of threshold values, is carried out without warning the driver in order not to disturb them.

10. The machine as claimed in any one of claims 1 to 9, wherein the machine is configured to, when the determined values of the pair of parameters corresponding to the speed of movement and to the arm angle exceed a third pair of associated threshold values, of which at least one of said threshold values is greater than the corresponding threshold value of the second pair, trigger transmission to the remote server (31) of data relating to the determined values of said parameters, and also the emission of a visual and/or audible signal using a device of the machine, present outside the cab of the machine, to warn the external environment of the machine.

11. An assembly comprising a machine as claimed in any one of claims 1 to 10 and said remote server (31).

12. A method for warning of driving risk, in particular of risk of tipping over, for a handling machine (1) comprising a wheeled chassis (2) and a lifting arm articulated to the wheeled chassis (2) so as to be able to be pivoted between a lowered position and a raised position, characterized in that the method comprises the following steps:
determination of first values of the parameters of speed of movement and of arm angle of the machine;
comparison of the first determined values of said parameters with first threshold values,
as a function of the result of the comparison, triggering at least one first warning action from the following group of actions:
transmission to a remote server (31) of data relating to the determined values of said parameters; and
emission of a visual, and/or audible, and/or vibratory signal to warn the driver of the machine;
the method also comprising the steps of:
determination of second values of said parameters of the machine;
comparison of the second determined values of said parameters with second threshold values;
as a function of the result of the comparison, triggering at least one second action, different from said at least one first action, from said group of actions.

13. A non-transient computer program product comprising program code instructions for executing the steps of a method as claimed in claim 12 when said program is executed by a processor of a handling machine.
